(19) United States
(12) Patent Application Publication
(10) Pub. No.: US 2023/0406759 A1
(43) Pub. Date: Dec. 21, 2023

(54) ENAMEL PASTE COMPOSITIONS AND METHODS OF COATING AND CHEMICAL STRENGTHENING GLASS SUBSTRATES

(71) Applicants: FENZI AGT NETHERLANDS B.V., Maastricht (NL); MAXFORD TECHNOLOGY LIMITED, Hong Kong (CN)

(72) Inventors: Svetlana EMELIANOVA, Maastricht (NL); Jean Luc LOONTJENS, Maastricht (NL); Maxence VALLA, Maastricht (NL); Kefeng LI, Shenzhen (CN); Ren XU, Shenzhen (CN)

(21) Appl. No.: 18/032,321

(22) PCT Filed: Sep. 28, 2021
(86) PCT No.: PCT/EP2021/076616

§ 371 Date: Apr. 17, 2023

(30) Foreign Application Priority Data
Oct. 16, 2020 (GB) 2016442.2

(51) Int. Cl. C03C 17/04; C03C 21/00; C03C 8/22

(52) U.S. Cl. CPC C03C 17/04; C03C 21/002; C03C 2217/485; C03C 2217/452; C03C 8/22

(57) ABSTRACT

A paste for coating a glass substrate which, after coating, is subjected to firing and chemical strengthening by ion exchange to form an enamel coated, chemically strengthened glass product, the paste containing
an organic carrier fluid;
a first inorganic frit having a first softening point; and
a second inorganic frit having a second softening point,
   wherein the softening point of the first inorganic frit is higher than the softening point of the second inorganic frit such that the second inorganic frit can be softened and sintered at a temperature lower than the softening point of the first inorganic frit, and
   wherein the first inorganic frit includes an exchangeable ion content which can be ion exchanged to chemically strengthen the first inorganic frit.

### FIELD

The present specification relates to enamel paste compositions and methods of coating and chemical strengthening glass substrates.

### BACKGROUND

Enamels are widely used to decorate or produce coatings on substrates such as glass, metal and ceramic substrates. Applications include tableware, signage, tiles, electronic device cover glass, automotive glass, architectural glass, etc. Enamels are especially useful in forming coloured borders around glass sheets used for windows and screens, e.g. electronic device cover glass and automotive windshields. The coloured borders enhance appearance and prevent degradation of underlying adhesives by UV radiation. Moreover, the coloured borders may conceal buss bars and wiring connections.

Enamels typically comprise pigment(s) and glass frit(s). In general, they are applied to a substrate (e.g. a glass surface) in an organic carrier fluid as a paste or ink, e.g. by screen printing or inkjet printing. In the present specification the term “paste” shall be used and it will be understood that this includes compositions which may also be referred to as inks, e.g. for inkjet printing.

The enamel pastes thus comprise particles of pigment and glass frit dispersed in a liquid dispersion medium. After application of a coating of paste to the substrate, the paste is typically dried and the applied coating undergoes firing, i.e. is subjected to heat treatment to cause at least a part of the frit particles to soften and fuse together, and fuse to the substrate, thereby forming an enamel coating adhered to the substrate. During firing, the pigment itself typically does not soften, but is affixed to the substrate by or with the frit.

Glass sheets for use in certain applications are subjected to a pressure forming process to bend the glass into the desired final shape. Typically, such glass sheets are coated in the desired region with a paste via a printing process prior to being subjected to press-bending at elevated temperatures. The elevated temperature employed during this process causes the coating to undergo firing whilst softening the glass sheet, which can then be formed into a desired final shape using a forming die or mould. Pressure forming is used, for example, in automotive windows, electronic device cover screens, the production of glass bottles, architectural glass and appliance glass. In these examples, it may also be desirable to apply an enamel for decorative and/or functional reasons.

One problem with such a method is that during the press-bending process the enamel may adhere (“stick”) to the die or mould employed thus damaging the enamel coating. As such, the enamel paste must be formulated so as to be low-stick at the press-bending temperature to alleviate the problem of adhesion to the die or mould.

In addition to the above, for many applications it is desirable to produce glass products with increased strength. This may be required to achieve an increase in strength for a given application and/or to enable thinner glass to be utilized thereby saving on material requirements and reducing weight while retaining a desired level of strength. In this regard, glass materials have been developed which can be chemically strengthened. Such glass materials comprise ions which can be exchanged with larger ions in an ion exchange process. For example, the glass material may comprise sodium ions which can be exchanged with potassium ions. Chemical strengthening is thus a process that toughens the surface of glass by replacing smaller, e.g. sodium, ions with larger, e.g. potassium, ions. The ion exchange creates a thin layer of high compression on the surface which results in a layer of tension in the center. The process is performed by submerging the glass in a molten salt bath, e.g. molten KNO₃.

For applications where non-planar, chemically strengthened glass is required, the glass can be subjected to a press-bending process to achieve the desired shape and then subjected to the chemical strengthening process. This ordering is preferable as it is easier to press-bend the glass prior to strengthening. Furthermore, press-bending after chemical strengthening could lead to a reduction in the strength of the final product.

Such shaped and chemically strengthened glass screens are desired for mobile phone cover screens. In recent years there has been a move towards using glass cover screens which are 3D shaped. For example, the edges of the screen may be curved for aesthetic appeal and/or to avoid sharp edges while enabling the glass screen to extend to the outer edge of the mobile device to increase the screen area for a given device size. It is also desired to have a higher strength screen to alleviate breakages if the device is dropped or otherwise subjected to an impact force. Further still, it is desired to provide a thin, lightweight device which requires a thin screen. Chemical strengthening aids in reducing glass thickness while still achieving the strength requirements for a robust mobile device.

Such shaped and chemically strengthened glass screens are also desirable in other applications. For example, in automotive there is a drive to more efficient, lower weight vehicles while retaining or improving safety standards. The use of chemically strengthened glass windows enables the provision of thinner, lower weight windows while retaining high strength performance. These features are also desirable for electric and hydrogen fuel cell vehicles to aid performance characteristics.

Such applications also often require an enamel coating on the chemically strengthened glass. Such an enamel coating may be applied after chemical strengthening. However, firing of an enamel paste on a chemically strengthened glass substrate generally leads to a reduction in the strength of the glass substrate. For example, heating a chemically strengthened glass substrate to fire the enamel coating can lead to ion migration within the glass substrate reducing the chemical strengthening previously imparted to the glass substrate.

One approach is to utilize a coating which does not require firing at such elevated temperatures. For example, an organic ink may be used in place of an enamel. However, such organic inks are not as hard wearing and scratch resistant as enamel coatings. Furthermore, if the glass has undergone a shaping process prior to chemical strengthening, then the application of a coating after the shaping and chemical strengthening steps requires printing on a non-planar substrate which is time consuming and expensive.

As such, it would be desirable to be able to apply an enamel coating prior to chemical strengthening and, for non-planar products, prior to any shaping process, such that the enamel coating is applied when the glass substrate is still in its planar, non-strengthened form.

In this regard, U.S. Pat. No. 9,487,439B2 suggests a method of decorating and strengthening a glass substrate, the method comprising:
a. applying an enamel composition to the glass substrate, the enamel composition including a pigment and between 45-100 wt % glass enamel frit comprising at least one exchangeable alkali-metal ion,
b. firing the glass substrate at a firing temperature sufficient to flow and sinter the glass enamel frit and thereby form a coloured enamel adhered to the glass substrate, and
c. placing the enamelled glass substrate in a bath of a molten salt, the molten salt including a monovalent metal ion larger than the exchangeable alkali-metal ions in the glass,
wherein the glass enamel frit has a softening point that is between the temperature of the molten bath and a softening point of the glass substrate such that the coloured enamel remains as a decorative functional layer on the glass substrate.

U.S. Pat. No. 9,487,439B2 specifies that:

“The useful frits will have softening points that fall in the range between the temperature of the molten ion exchange bath and the softening point of the substrate glass. For instance, the molten potassium nitrate bath commonly used for ion exchange is generally operated in the range of about 350 to about 400° C. Soda-lime substrate glass is generally processed at temperatures from about 600 to about 700° C. The window of softening points for such a system is therefore, about 425° C. to about 575° C.”

The key features of the glass frit for the enamel paste include: (i) it must have a softening point lower than that of the substrate such that it can be fired on the substrate without damaging the substrate; (ii) it must have a softening point higher than the temperature of the molten bath such that the enamel coating is not damaged by the molten bath during the chemical strengthening process; (iii) the glass frit must comprise exchangeable ions such that the glass within the enamel coating can be chemically strengthened; and (iv) the glass frit should possess a coefficient of thermal expansion (CTE) close to that of the substrate glass.

U.S. Pat. No. 948,743,962 lists a large number of potential oxide components for the glass frit and a range of potential quantities for these components. It is indicated that these components and quantities are typical for lead-free frits useful for glass decoration. All examples in U.S. Pat. No. 948,743,962 use a commercially available lead-free, sodium-containing glass frit in the paste.

### SUMMARY OF INVENTION

The present inventors have found it difficult to identify a commercially available frit which adequately fulfils all requirements for coating and chemical strengthening glass products for certain demanding applications such as mobile phone cover glass and automotive applications. A compromise is required between the requirements of the frit to form a good enamel coating and the requirements of the frit to provide a very strong enamel coated glass product. Commercially available frits which form good enamel coatings, and which meet the softening point requirements to enable the formation of an enamel coating on a substrate which subsequently survives a chemical strengthening process, have been found to result in a glass product which isn't sufficiently strong for demanding application requirements.

There is thus a need for enamel-forming compositions which provide good processing on various chemically strengthened glass substrates and result in coated glass articles having improved properties. In particular, there is a need for enamel-forming compositions wherein the enamel can be readily printed onto a substrate which is subjected to chemical strengthening and which results in a coated glass product with excellent toughness and strength. The enamel should also provide a good quality coating, with good physical, optical, and chemical properties.

The present specification aims to address these issues. In particular, the present specification describes a solution in which the enamel paste is formulated using at least two inorganic frits: a first frit which is tailored to provide improved toughness and strength, and, in certain examples, is a powdered form of the same material used for the substrate (e.g. Gorilla™ Glass from Corning™); and a second frit which has a lower softening temperature which is tailored to provide a good quality, sintered enamel coating on firing but which has a sufficiently high softening temperature so as not to be damaged by the chemical strengthening process performed after coating and firing.

The use of the same or similar material as the substrate in the frit formulation of the paste has been found to be advantageous in improving the toughness and strength of the enamel coated product after firing and chemical strengthening. This material has already been optimized for the chemical strengthening process used for chemical strengthening of the substrate. As such, it is an ideal choice for the coating. The use of the same or similar material in the coating and substrate also ensures a good thermal expansion coefficient match between the coating and the substrate.

Of course, the problem with using the same inorganic material for the coating and the substrate is that the frit in the coating cannot be sintered without also softening the substrate. As such, the present specification provides a paste which has a second frit with a lower softening point which can be sintered at a temperature lower than the softening point of the substrate and the first frit in the paste composition. This results in an enamel coating comprising particles of the first frit embedded in a continuous matrix of the sintered second frit. Since the first frit is not softened and sintered during the sintering of the second frit, and to ensure that a smooth, good quality enamel coating is achieved, the first frit may be processed to provide a fine powder with small particle size.

Despite the fact that the first frit has not reached its softening point and sintered during the coating sintering step, and remains as discrete particles distributed through the sintered second frit, it has been found that significant quantities of the first frit can be incorporated into the paste formulation while still achieving a good quality enamel coating.

Furthermore, it has been found that this leads to an improved toughness/strength in the final enamel coated glass product after chemical strengthening, despite the fact that the first frit remains in an un-sintered form. While not being bound by theory, one possible mechanism is that the first frit, being of the same or similar material to the substrate, is strengthened in the same or similar manner to the substrate material. The ion exchange process in which smaller ions are replaced with larger ions creates a thin layer of high compression on the surface of the enamel in a similar manner to the uncoated surface regions of the substrate. Another possible mechanism is that in-situ ion exchange between the first and second frits may occur before the chemical strengthening step. One or more of the aforementioned mechanisms may contribute to the chemical strengthening of the enamel coating. Regardless of the underlying mechanism, it has been found that this chemical strengthening of the enamel coating can be achieved without breaking up the enamel coating. In addition, a better matching of enamel and substrate properties is achieved leading to an improved, chemically strengthened, enamel coated glass product.

In fact, analytical results indicate that the second (lower softening point) frit not only acts as a sintering aid during enamel coating formation but also plays an important role in the chemical strengthening mechanism for the multi-frit system. As such, the composition of the second (lower softening point) frit can be formulated such that, in combination with the first (higher softening point) frit, it provides a multi-frit system which is better optimized to a chemical strengthening process. In this regard, the second frit is advantageously a bismuth silicate glass frit (e.g. comprising 40-70 wt % Bi₂O₃ and 10-40 wt % SiO₂) or a zinc borosilicate glass frit. Furthermore, the first frit is advantageously an aluminosilicate glass frit (e.g. comprising 50-70 wt % SiO₂ and 15-25 wt % Al₂O₃). The combination of an aluminosilicate glass frit with a bismuth silicate glass frit or a zinc borosilicate glass frit has been found to be particularly advantageous in being optimized for a chemical strengthening process.

Advantageously, for shaped glass products, the step of sintering the second frit in the paste is performed at the same time as press-bending of the glass substrate. As such, the process involves: depositing/printing the duel-frit paste on a flat, unstrengthened glass substrate; prefiring to remove the carrier liquid component of the paste; press-bending at elevated temperate (e.g. between 700° C. and 800° C.) to shape the substrate and sinter the second frit in the coating to form the enamel coating during shaping of the substrate; and then subjecting the enamel coated glass substrate to chemical strengthening, e.g. by submerging in a molten salt bath. The resulting enamel exhibits mechanical and optical properties which fulfil requirements of demanding end applications. For example, the resulting enamel may exhibit an Excluded L value measurement below 5 and an optical density above 3.

### BRIEF DESCRIPTION OF THE DRAWINGS

For a better understanding of the present invention and to show how the same may be carried into effect, certain embodiments of the present invention will now be described by way of example only with reference to the accompanying drawings, in which:

FIG. 1 shows a flow diagram of the basic process steps for enamel coating and chemically strengthening a glass substrate;

FIG. 2 shows a schematic drawing of an enamel coated, chemically strengthened glass product formed using the process show in FIG. 1;

FIG. 3 shows a flow diagram of the basic process steps for enamel coating, press-bending, and chemically strengthening a glass substrate; and

FIG. 4 shows a schematic drawing of a shaped, enamel coated, chemically strengthened glass product formed using the process show in FIG. 3.

### DETAILED DESCRIPTION

The present specification provides a paste for coating a glass substrate which, after coating, is subjected to firing and chemical strengthening by ion exchange to form an enamel coated, chemically strengthened glass product. The paste comprises an organic carrier fluid, a first inorganic frit having a first softening point, and a second inorganic frit having a second softening point, wherein the softening point of the first inorganic frit is higher than the softening point of the second inorganic frit such that the second inorganic frit can be softened and sintered at a temperature lower than the softening point of the first inorganic frit and also lower that the softening point of the substrate on which the coating is applied.

It may be noted that “softening point” is a well-known and well-used parameter in the glass materials field. Softening point means the first temperature at which indications of softening or deformation of a frit are observed. This can be measured using hot stage microscopy (HSM). Additionally, or alternatively, this can be measured via dilatometry where the dilatometric softening point is the temperature at which viscosity of the frit is 10^{11.3} dPa·s.

An alternative or additional way of defining the inorganic frits in the paste is in terms of glass transition temperatures. In this case, the glass transition temperature of the first inorganic frit is higher than the glass transition temperature of the second inorganic frit. In other respects, the paste can be defined in the same way as described herein.

Additional frits can be added to the mixture to improve the coefficient of thermal expansion of the enamel or to improve the flowability of the resulting mixture. The first inorganic frit comprises an exchangeable ion content which can be ion exchanged to chemically strengthen the frit in the enamel coating, e.g. by in-situ ion exchange and/or during the same process used to chemically strengthen the glass substrate on which the enamel coating is disposed. The second inorganic frit may also comprise an exchangeable ion content which can be ion exchanged to chemically strengthen the second inorganic frit in addition to the first inorganic frit. However, the chemical strengthening characteristics of the second inorganic frit (at least in isolation of the first frit) is generally lower than for the first inorganic frit as the composition of the second inorganic frit is not optimized for glass strengthening but rather must be tailored for its sintering characteristics. As such, the exchangeable ion content of the second inorganic frit is usually lower than the exchangeable ion content of the first inorganic frit and/or the surrounding glass matrix is such that the ion exchange doesn't generate the same degree of chemical strengthening as for the first inorganic frit and the glass substrate material, at least in isolation of the first frit. That said, as previously discussed, preliminary analytical studies have also indicated that when present in the multi-frit system, the second (low softening point) frit may well contribute to the chemical strengthening mechanism more than expected, and may be equally important to the chemical strengthening process as the first frit, even if the exchangeable ion content of the second frit is lower than that of the first frit.

As indicated in the summary section, according to certain examples the first inorganic frit can be made of the same material as the glass substrate on which the enamel coating is applied. However, in other examples the first inorganic frit may be made of a different material to that of the substrate so long as it is a material which is adapted to have an exchangeable ion content which can be ion exchanged to chemically strengthen the frit in the enamel coating by in-situ ion exchange and/or during the same process used to chemically strengthen the glass substrate on which the enamel coating is disposed. That is, the first inorganic frit is a material which is adapted for chemical strengthening performance and is not required to have a low softening point for sintering on the substrate. For example, the first inorganic frit may be formed of the same material as the substrate or another type of glass material which is adapted/optimized for chemical strengthening performance rather than for softening and flow characteristic associated with conventional enamel coating formation.

One factor determining the ability of a glass material to be chemically strengthened via ion exchange is clearly the quantity and type of exchangeable ions within the glass material. In this regard, the first inorganic frit may comprise an amount of exchangeable ions, defined by weight of the equivalent oxide, of: no less than 6 wt %, 7 wt %, or 8 wt %; no more than 15 wt %, 12 wt %, 10 wt % or 9 wt %; or within a range defined by any combination of the aforementioned upper and lower limits. In this regard, it should be noted that glass compositions are conventionally defined by the percentage by weight of the oxide components used to fabricate the glass composition. As such, it is appropriate to define the exchangeable ion content in terms of the equivalent oxide content used in the fabrication of the glass material.

The exchangeable ion content may be provided by alkali metal ions such as lithium and/or sodium. Particularly useful are high sodium content glasses in which the sodium ion content is exchangeable with potassium ions when placed in a molten bath comprising potassium ions. For example, if the exchangeable ions are sodium ions, then the first inorganic frit may comprise 7-10 wt % Na₂O. That said, it is envisaged that other ion exchange systems may be utilized. For example, it is also known to use caesium ions to chemically strengthen glass.

It is important to note that the chemical strengthening of a glass material is not solely governed by its exchangeable ion content, e.g. its alkali metal content or sodium content to be more specific. The amount of chemical strengthening will also depend on the glass matrix surrounding the exchangeable ions. The surrounding glass matrix will affect the quantity, depth, and rate at which ions are exchanged in a molten ion exchange bath. Furthermore, the surrounding glass matrix will affect the amount of stress that is generated by the exchange of ions. As such, it should be noted that tailoring a glass material to optimize its ability to be chemically strengthened is not just a matter of selecting a glass material with a high exchangeable ion (e.g. sodium) content.

According to certain examples the first inorganic frit can be an aluminosilicate glass frit, optionally comprising 50-70 wt % SiO₂ and 15-25 wt % Al₂O₃. As previously indicated, the aluminosilicate glass frit may comprise an exchangeable ion content in the form of a Na₂O content as previously defined. In addition, the first inorganic frit further comprises one or more of the following: 1-5 wt % Li₂O; 0.2-2 wt % K₂O; 0-1 wt % CaO; 0-1 wt % MgO; 0-1 wt % ZrO₂; 0-1 wt % B₂O₃; and 1-5 wt % P₂O₅. These components and quantities equate to commercially available glass materials tailored for chemical strengthening such as Gorilla™ Glass from Corning™.

Since the first inorganic frit is not required to soften and sinter when forming the enamel coating, these requirements being met by the second inorganic frit in the paste, then the first inorganic frit is not required to have a softening point which is lower than the softening point of the glass substrate. The first inorganic frit may have a softening point of: no less than 500° C., 550° C., 575° C., 600° C., 650° C., 700° C., 750° C., or 800° C.; no more than 1000° C., 900° C., or 850° C.; or within a range defined by any combination of the aforementioned upper and lower limits. In certain examples the softening point of the first inorganic frit is the same, or substantially the same, as that of the glass substrate, e.g. if the first frit is made of the same material as the substrate.

In addition to improving the chemical strengthening of the enamel coating, the first inorganic frit also functions to provide the enamel coating with a better thermal expansion coefficient match with the substrate. The glass substrate can have a thermal expansion coefficient which is more closely matched to the first inorganic frit than the second inorganic frit. This will usually mean that the first inorganic frit has a coefficient of thermal expansion which is lower than a thermal expansion coefficient of the second inorganic frit. If the substrate is made of the same material as the first inorganic frit then the material of the substrate and the first inorganic frit will exhibit the same thermal expansion coefficient.

The paste may comprise an amount of the first inorganic frit, as a weight percentage of a solid content of the paste, of: no more than 50 wt %, 40 wt %, 30 wt %, 20 wt % or 15 wt %; no less than 2 wt %, 5 wt %, 8 wt %, or 10 wt %; or within a range defined by any combination of the aforementioned upper and lower limits. The lower limit is determined by the amount of chemically strengthened glass which is required to achieve the desired strength/toughness in the end application. The upper limit is determined by the amount of such material which can be loaded into the enamel composition while still providing a good quality enamel coating, with good aesthetic, physical, optical, and chemical properties.

As previously indicated, the second inorganic frit of the enamel paste composition has a lower softening temperature than the first glass frit and the substrate and is one which is selected to provide a good quality, sintered enamel coating on firing. The second inorganic frit should still have a sufficiently high softening temperature so as not to be damaged by the chemical strengthening process performed after coating and firing. As such, the second inorganic frit can be selected to be a more conventional glass frit used in enamel coatings, albeit one which has softening and flow characteristic associated with conventional enamel coating formation within the required temperature window defined at a lower end by the temperature of the molten ion exchange bath and at an upper end by the softening point of the glass substrate.

That said, the second inorganic frit can be tailored to optimize its compatibility with the first inorganic frit and the glass substrate material in order to optimize the characteristics of the end product. As previously indicated, the second frit can play a role in the chemical strengthening process in addition to functioning as a sintering aid during enamel coating. The second inorganic frit may, for example, be a bismuth silicate glass frit and may comprise 40-70 wt % or 45-70 wt % Bi₂O₃ and/or 10-40 wt % or 20-40 wt % SiO₂. Alternatively, the second frit may be a zinc borosilicate glass frit. The second inorganic frit may also comprise an exchangeable ion content which can be ion exchanged to chemically strengthen the second inorganic frit in addition to the first inorganic frit. However, the exchangeable ion content of the second inorganic frit is usually lower than the exchangeable ion content of the first inorganic frit. For example, the second inorganic frit may comprise an amount of exchangeable ions, defined by weight of the equivalent oxide, of: no less than 0 wt %, 1 wt %, 2 wt %, or 2.8 wt %; no more than 6 wt %, 5 wt %, 4 wt % or 3.5 wt %; or within a range defined by any combination of the aforementioned upper and lower limits. In certain examples, the second inorganic frit comprises 1-5 wt % Na₂O.

In addition, the second inorganic frit may further comprise one or more of the following: 2.5-5.5 wt % B₂O₃; 3-5 wt % Li₂O; 1-2 wt % ZnO; 0-1 wt % P₂O₅; 0-1 wt % MgO; and 0-1 wt % CuO. These components and quantities for the second inorganic frit have been found to be suitable for use in combination with a first inorganic frit and glass substrate formed of Gorilla™ Glass from Corning™. It is also envisaged that the formulation will be suitable for use which similar chemically strengthened glass materials.

As previously indicated, the second inorganic frit should be selected to have softening and flow characteristics for enamel coating formation within a temperature window defined at a lower end by the temperature of the molten ion exchange bath and at an upper end by the softening point of the glass substrate. The specific material selected, and the specific softening point of the material, will be somewhat dependent on the material selected for the substrate, the first glass frit, and the temperature used for the molten ion exchange bath, as these selections will set the temperature window for sintering the second inorganic frit. However, typically, the second inorganic frit is selected to have a softening point, within the paste/enamel composition, of: no more than 650° C., 600° C., 575° C., 550° C., or 500° C.; no less than 350° C., 375° C., 400° C., 425° C., 450° C., or 475° C.; or within a range defined by any combination of the aforementioned upper and lower limits.

The softening point of the second inorganic frit should be lower than its sintering temperature. Typically, the second inorganic frit should have a sintering temperature in a range 700° C. and 850° C. (optionally 700° C. and 800° C.). In this regard, it should be noted that the second inorganic frit may, on its own, be fused within a lower temperature range, but when it is used together with the first frit (and other components of the paste such as pigment) it provides a suitable sintering temperature range appropriate for the chemical strengthening process. That is, the second frit only provides a sintering temperature window suited to the chemical strengthening process when it is used together with other components in the paste/enamel and so the sintering behaviour of the second frit as described in this specification should be understood in this context. The softening and firing behaviour of the second frit must be selected to provide the required characteristics when combined with the other components in the paste/enamel. Furthermore, typically the first inorganic frit is not sintered at this temperature such that the second inorganic frit sinters around un-sintered particles of the first inorganic frit with the second inorganic frit forming a continuous, fused, sintered glass matrix in which particles of the first inorganic frit are distributed.

As previously indicated, for certain applications the paste should provide an enamel coating which is dark in colour and has a low L value. It has been found that the crystallisation behaviour of the second frit is important to achieve low L values. As such, the second frit may be selected to be one which is a low crystallising frit.

The paste may comprise an amount of the second inorganic frit, as a weight percentage of a solid content of the paste, of: no more than 80 wt %, 60 wt %, 50 wt %, 45 wt % or 43%; no less than 20 wt %, 30 wt % or 40 wt %; or within a range defined by any combination of the aforementioned upper and lower limits. The lower limit is determined by the amount of second inorganic frit which is required to form a continuous, fused, sintered glass matrix in which particles of the first inorganic frit are distributed. The upper limit is dependent on the amount of first inorganic frit which is required to achieve the desired strength after chemically strengthening.

According to certain applications, it is desirable that the paste is capable of being fired and press-bent at a temperature in a range 700° C. and 850° C. (optionally 700° C. and 800° C.) without sticking to a press-bending apparatus. As such, the second inorganic frit should be formulated to sinter within this temperature range and have anti-stick properties at this sintering temperature.

For applications in which a coloured enamel coating is desired, the paste may further comprise a pigment. The type of pigment will depend on the desired colour, optical density, etc. for the end application. For certain applications, the pigment may comprise one or more of Cr, Cu, Co and Mn. Furthermore, the paste may comprise an amount of pigment, as a weight percentage of a solid content of the paste, of: no more than 30 wt %, 25 wt %, or 22 wt %; no less than 10 wt %, 15 wt % or 19 wt %; or within a range defined by any combination of the aforementioned upper and lower limits.

The paste may also comprise a seed frit which may, for example, comprise ZnO and SiO₂. The paste may comprise an amount of seed frit, as a weight percentage of a solid content of the paste, of: no more than 20 wt %, 15 wt %, or 12 wt %; no less than 5 wt %, 7 wt % or 9 wt %; or within a range defined by any combination of the aforementioned upper and lower limits.

The paste compositions as described above may be used in a method of coating and chemically strengthening a glass substrate. The glass substrate may be an electronic device cover glass, a mobile phone cover glass, an automotive window, or an architectural window.

The present specification also provides a method of coating a glass substrate comprising:
depositing a paste as described herein onto a glass substrate, the glass substrate comprising an exchangeable ion content which can be ion exchanged to chemically strengthen the glass substrate, and wherein the glass substrate has a softening point lower than the softening point of the second inorganic frit of the paste;
heating the glass substrate to sinter the second inorganic frit of the paste forming an enamel coated glass substrate; and
subjecting the enamel coated glass substrate to an ion exchange process to exchange at least a portion of the exchangeable ion content in the substrate and the first inorganic frit to chemically strengthen the enamel coated glass substrate.

In the aforementioned method, the glass substrate may comprise the same exchangeable ions as the first inorganic frit and in the same or similar quantities. For example, the glass substrate may comprise an amount of exchangeable ions, defined by weight of the equivalent oxide, of: no more than 15 wt %, 12 wt %, 10 wt % or 9 wt %; no less than 6 wt %, 7 wt %, or 8 wt %; or within a range defined by any combination of the aforementioned upper and lower limits. According to certain examples, the glass substrate comprises 7-10 wt % Na₂O.

Similarly, the softening point of the glass substrate may be the same or similar to that of the first inorganic frit. That is, wherein the glass substrate may have a softening point of: no less than 500° C., 550° C., 575° C., 600° C., 650° C., 700° C., 750° C., or 800° C.; no more than 1000° C., 900° C., or 850° C.; or within a range defined by any combination of the aforementioned upper and lower limits.

The glass substrate may have a thermal expansion coefficient which is more closely matched to the first inorganic frit than the second inorganic frit.

The substrate may also have other components which are the same or similar to those forming the material of the first inorganic frit. For example, the substrate may be an aluminosilicate glass and may comprise, for example, 50-70 wt % SiO₂ and 15-25 wt % Al₂O₂. In addition, the glass substrate may further comprise one or more of the following: 1-5 wt % Li₂O; 0.2-2 wt % K₂O; 0-1 wt % CaO; 0-1 wt % MgO; 0-1 wt % ZrO₂; 0-1 wt % B₂O₃; and 1-5 wt % P₂O₅. These components and quantities equate to commercially available glass materials tailored for chemical strengthening such as Gorilla™ Glass from Corning™. According to certain examples, the glass substrate is formed of the same material as the first inorganic frit in the paste.

In the method of forming the enamel coating, the heating step may comprise heating, e.g. to a temperature in a range 700° C. to 800° C., the glass substrate to a temperature between the softening temperatures of the first and second inorganic frits of the paste to sinter the second inorganic frit forming the enamel coated glass substrate without softening the first inorganic frit or the glass substrate.

The method can further comprise a press-bending step to shape the glass substrate. In this regard, the glass substrate is further subjected to press-bending to shape the glass substrate after depositing the paste on the substrate and prior to subjecting the glass substrate to the ion exchange process to chemically strengthen the glass substrate. It is preferred that the substrate is shaped by press-bending at the same time as the second inorganic frit is sintered to form the enamel coating on the glass substrate. In this way, the coating is sintered at the same time as the shaping of the substrate without the requirement for any additional processing step to form the enamel coating.

After sintering of the enamel coating and shaping of the glass substrate, the enamel coated product is subjected to chemical strengthening via ion exchange. The ion exchange process comprises placing the enamel coated glass substrate in a molten ion exchange bath, e.g. a molten bath of KNO₃. The resultant coated and chemically strengthened glass product has been found to have improved strength and toughness compared to other enamel coated and chemical strengthened glass products and is advantageous for use in a range of applications. For example, the coated glass product may be one of: an electronic device cover glass; a mobile phone cover glass; an automotive window; or an architectural window.

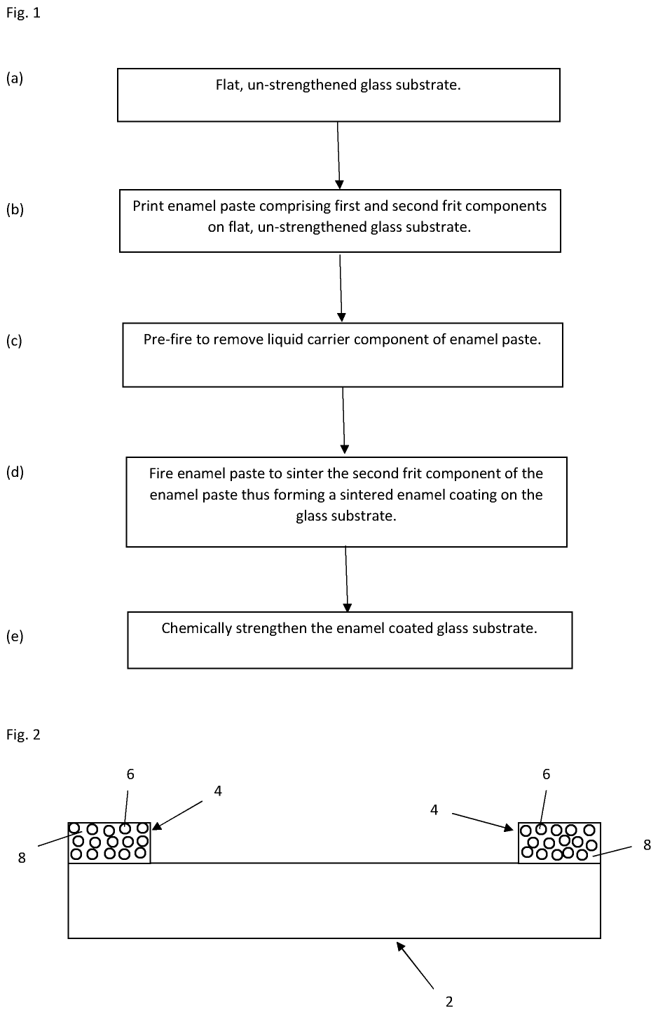

FIG. 1 shows a flow diagram of the basic process steps for enamel coating and chemically strengthening a glass substrate. The method comprises the following steps:
(a) Start with a flat, un-strengthened glass substrate made of a glass material. The glass material is formulated to have small ions (e.g. sodium ions) which can be exchanged for larger ions (e.g. potassium ions) when placed in a molten salt bath. The material of the glass substrate also has a matrix structure which enables the ion exchange and which generates stress in a surface layer when the exchange takes place to increase the strength/toughness of the glass substrate. An example of a suitable glass material for the substrate is Gorilla™ Glass from Corning™.
(b) Print an enamel paste comprising first and second frit components on the flat, un-strengthened glass substrate. As previously described, the first frit component is selected for chemical strengthening and has similar or the same composition and properties as the material of the substrate. In contrast, the second frit has a composition and properties which are selected to provide a good quality enamel coating when sintered on the substrate.
(c) Pre-fire to remove the liquid carrier component of enamel paste. When forming an enamel coating it is typical to heat the paste on the substrate after deposition to evaporate the liquid carrier prior to the main firing step. This heating is at a temperature lower than the main firing/sintering temperature.
(d) After pre-firing, the main firing step is performed to sinter the second frit component of the enamel paste thus forming a sintered enamel coating on the glass substrate. In this step the second frit of the enamel coating softens and flows such that the frit particle fuse into a continuous glass matrix forming the enamel coating. Typically, the first frit does not soften and flow during this step but rather the first frit remains as discrete particles embedded in the continuous glass matrix formed by the second frit.
(e) Finally, the coated the enamel coated glass substrate is chemically strengthened by submerging in a molten salt bath. Small ions in the glass substrate and the first frit component of the enamel coating are exchanged with larger ions generating stress in a surface layer which strengthens and toughens the glass substrate and the enamel coating. The second frit component of the enamel coating (formed into a sintered coating in the preceding firing step) may also comprise an amount of exchangeable ions but the quantity of such ions and/or the amount of stress and strengthening/toughening generated in the second frit component will be generally less than that of the substrate and first frit component.

FIG. 2 shows a schematic drawing of an enamel coated, chemically strengthened glass product formed using the process show in FIG. 1. It is to be noted that this is an illustrative drawing only and is not to scale. The product comprises a chemically strengthened glass substrate 2 and an enamel coating 4. The enamel coating 4 comprises particles of the first frit 6 disposed within a continuous glass matrix 8 formed by the second frit.

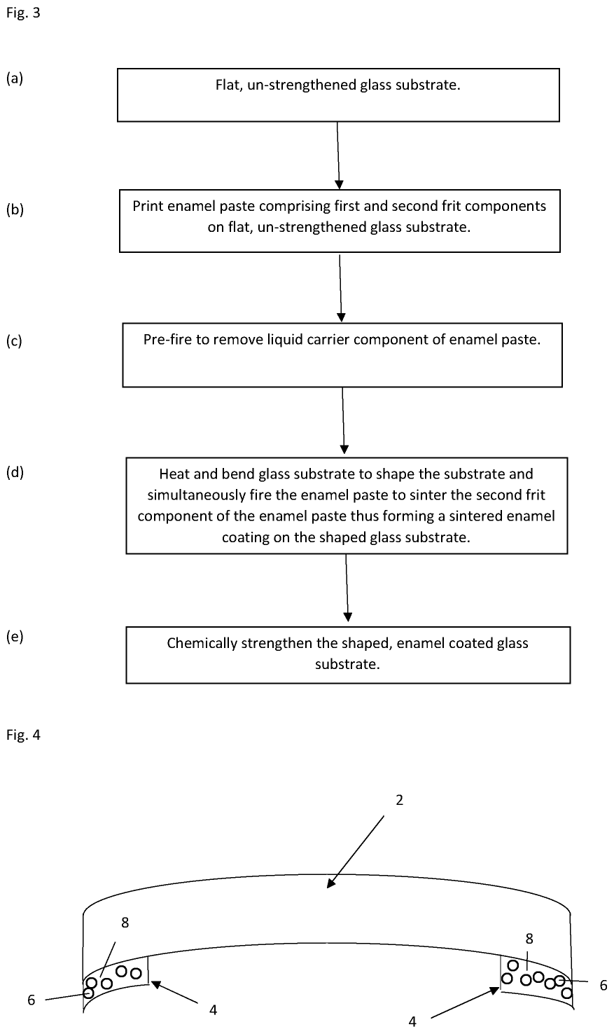

FIG. 3 shows a flow diagram of the basic process steps for enamel coating, press-bending, and chemically strengthening a glass substrate. The processes is very similar to that show in FIG. 1 with the exception that in step (d) the coated glass substrate is both fired to form the enamel coating and also press-bent to shape the coated glass substrate into a desired (non-planar) shape for an end application such as a shaped cover screen for a mobile electronic device or an automotive window. In this regard, the second frit component of the enamel paste is selected such that it is sintered at the temperature used to heat and shape the substrate.

FIG. 4 shows a schematic drawing of a shaped, enamel coated, chemically strengthened glass product formed using the process show in FIG. 3. The structure is similar to the product shown in FIG. 2 but with a shaped, non-planar substrate. The product comprises a chemically strengthened, shaped glass substrate 2 and an enamel coating 4. The enamel coating 4 comprises particles of the first frit 6 disposed within a continuous glass matrix 8 formed by the second frit.

As previously indicated, the paste compositions, coating and chemical strengthening methodologies as described herein can be used in a range of applications. One application is curved 3D mobile phone cover screens. In recent years certain manufacturers have introduced mobile phone designs which incorporate screens, e.g. made of Gorilla Glass 5, which are curved, particularly around the edges of the screen. The 3D forming and shaping process of Gorilla Glass 5 has to be done at temperatures above 750° C., and therefore manufacturers have to decorate their substrate with organic ink after the bending process since organic ink will never survive such extreme conditions. 3D decoration techniques for organic ink deposition have been developed, but this is a complicated process and one of the bottlenecks in the manufacturing process.

The present specification solves this 3D decoration problem, by providing an enamel paste composition which is compatible with both the bending process (at 760° C. in graphite mould) and the chemical strengthening process (in molten KNO₃) and which results in a strong/tough coated product. One of the main challenges is to retain a high glass strength/toughness provided by the use of Gorilla Glass 5 and chemical strengthening. The use of enamel tends to weaken the glass, and thus the limitation of this weakening is crucial. Commercial front mobile phone cover glass usually has a breakage value of 600 MPa. The process steps correspond to those shown in FIG. 3. The process starts with flat glass which is decorated with an enamel paste as described herein by screen printing. After drying at 150° C. for a few minutes, the enamel is pre-fired and the coated product bent at 760° C. in a graphite mould. After shaping of the coated glass, the coated glass is treated in a molten KNO₃ bath (at 450° C.) for 24 hours for chemical strengthening.

In this process for 3D mobile phone glass production, the enamel has the following properties:
A firing temperature between 700° C. and 850° C. (e.g. 700° C. and 800° C.)
Non-Stick properties between 700° C. and 850° C. (e.g. 700° C. and 800° C.)
Low glass weakening
Resistance to molten KNO₃ treatment

One enamel composition which has been developed for this application comprises two different glass components, a pigment, and a seed component. One of the glass components (^{˜}42 wt % of the solid content of the enamel paste) is a bismuth-silicate based glass frit with a relatively low alkali metal content (low relative to the substrate and the other glass component of the enamel composition). This glass frit has a softening point higher than the temperature of the molten KNO₃ bath used for chemical strengthening but lower than the softening point of the Gorilla Glass substrate. The other glass component of the enamel paste (^{˜}25 wt % of the solid content of the enamel paste) is formed of a milled glass powder of the same Gorilla Glass as the substrate to be coated, i.e. a high sodium content glass for ion exchanging with potassium to chemical strengthen the glass. It has been found that by including some Gorilla Glass in the enamel paste there is less glass weakening of the substrate due to the enamel coating. The enamel composition cannot be made wholly with Gorilla Glass as the enamel paste is required to soften and flow at a lower temperature than the substrate. As such, the two-glass component feature of the enamel composition is an important feature of the enamel compositions for this specification with the sintering glass component of the enamel paste forming a smaller proportion of the solid content of the enamel paste than would otherwise be the case without the addition of a non-sintering Gorilla Glass component in the enamel paste. During sintering, only the bismuth-silicate based glass frit is sintered—the sintering temperature is lower than that required to sinter the Gorilla Glass component of the enamel paste.

One of a range of paste compositions which has been developed comprises the following components (with the percentage quantities being in relation to the total solid content of the paste-not including the liquid carrier component):

| Component | wt % |
|---|---|
| Bismuth silicate glass | 43 |
| Gorilla ™ Glass | 25 |
| Seed | 11 |
| Pigment | 21 |

The composition of the bismuth silicate glass used in the aforementioned paste composition is as follows (wt %):

| | |
|---|---|
| Bi₂O₃ | 57.1 |
| SiO₂ | 29.9 |
| B₂O₃ | 4.5 |
| LiO₂ | 3.6 |
| Na₂O | 3 |
| ZnO | 1.4 |
| P₂O₅ | 0.3 |
| MgO | 0.3 |
| CuO | 0.3 |

The composition of the Gorilla™ Glass is as follows (wt %):

| | |
|---|---|
| SiO₂ | 58.6 |
| Al₂O₃ | 21.3 |
| Na₂O | 8.6 |
| Li₂O | 2.8 |
| K₂O | 0.8 |
| CaO | 0.12 |
| MgO | 0.23 |
| ZrO₂ | 0.29 |
| B₂O₃ | 0.2 |
| P₂O₅ | 3.8 |

The composition of the seed is as follows (wt %):

| | |
|---|---|
| ZnO | 73 |
| SiO₂ | 27 |

The composition of the pigment is as follows (wt %):

| | |
|---|---|
| Cr | 49 |
| Cu | 30 |
| Mn | 15 |

Subsequent work has indicated that the seed material is not essential to the compositions and thus can be left out. Furthermore, a range of different examples of paste compositions have been developed using different frits and pigments. Table 1 below shows thirteen different examples of paste compositions. The compositions of frits A to I are given in Table 2. Table 3 shows optical properties of resulting items after firing at 800° C. on a Gorilla Glass substrate. For certain application darker colour (lower L value) and higher optical density (higher OD) are preferred.

TABLE 1
Examples of paste compositions (weight percentage quantities being in relation to
the total solid content of the paste - not including the liquid carrier component)

| Examples | | #1 | #2 | #3 | #4 | #5 | #6 | #7 | #8 | #9 | #10 | #11 | #12 | #13 |
|---|---|---|---|---|---|---|---|---|---|---|---|---|---|---|
| Frits | A | 42.5 | | 32.6 | | 25.5 | | | 25.5 | 14.9 | 17.5 | 20.0 | | |
| | B | 25.5 | 68.1 | 25.4 | 25.5 | 23.2 | 59.8 | 25.5 | 23.2 | 14.9 | 7.5 | 4.9 | 15.0 | 10.0 |
| | C | | | 5.8 | 10.0 | 10.0 | 5.0 | 10.0 | 10.0 | | | 27.5 | 10.0 | 15.0 |
| | D | | | | | | | | | | | | 25.0 | 25.0 |
| | E | | | 14.9 | 14.9 | 14.9 | 9.6 | | | | | | | |
| | F | | | | | | | 14.9 | 14.9 | 25.0 | 40.1 | 10.0 | 10.0 | 10.0 |
| | I | | | | 28.4 | | | 28.4 | | 12.6 | | | | |
| Seed | J | 10.6 | 10.6 | | | | | | | | | | | |
| Pigments | K | 21.3 | 21.3 | | | | | | | 25.0 | 25.0 | 25.1 | | |
| | L | | | 20.0 | 19.9 | 25.1 | 23.7 | 19.9 | 25.1 | 4.9 | 7.3 | 10.1 | 37.5 | 37.5 |
| | M | | | 1.3 | 1.3 | 1.3 | 2.0 | 1.3 | 1.3 | 2.5 | 2.5 | 2.4 | 2.5 | 2.5 |

TABLE 2
Frit Compositions (weight percentage
quantities of equivalent oxides)

| | A | B | C | D | E | F | I | J |
|---|---|---|---|---|---|---|---|---|
| SiO2 | 25-35 | — | 63.8 | 26.63 | 16.4 | 13.98 | 32.71 | 27.1 |
| Bi2O3 | 55-65 | — | — | 43.46 | — | — | 61.45 | — |
| Li2O | 1-3 | — | 2.57 | 0.91 | — | — | 2.22 | — |
| B2O3 | 2-4 | — | — | — | — | — | 2.22 | — |
| Na2O | 1-3 | — | — | — | 7.11 | 9.91 | 0.39 | 0.59 |
| ZnO | 1-3 | — | 3.6 | 5.13 | 32.91 | 32.97 | — | 71.9 |
| F | 0-0.5 | — | — | — | 0.51 | 0.45 | — | — |
| CuO | 0-0.5 | — | — | — | — | — | 0.2 | — |
| MnO | 0-0.5 | — | — | — | — | — | 0.16 | — |
| Fe2O3 | 0-0.5 | — | — | — | — | — | 0.08 | — |
| Al2O3 | — | — | 22.34 | 5.89 | 3.61 | 3.35 | — | — |
| CaO | — | — | 4.92 | 2.93 | — | — | — | — |
| BaO | — | — | 2.51 | — | — | — | — | — |
| MgO | — | — | 0.27 | — | 0.58 | — | — | 0.41 |
| B2O3 | — | — | | 15.08 | 29.93 | 29.85 | — | — |
| K2O | — | — | — | — | 4.59 | 3.78 | 0.52 | — |
| ZrO2 | — | — | — | — | 2.5 | 1.45 | — | — |
| SrO | — | — | — | — | 0.97 | 1.01 | — | — |
| P2O5 | — | — | — | — | 0.86 | 0.85 | — | — |
| La2O3 | — | — | — | — | — | 1.49 | — | — |
| Ce2O3 | — | — | — | — | — | 0.9 | — | — |

TABLE 3
Optical properties of enamel coatings after
firing at 800° C. on Gorilla Glass substrate

| | #1 | #2 | #3 | #4 | #5 | #6 | #7 | #8 | #9 | #10 | #11 | #12 | #13 |
|---|---|---|---|---|---|---|---|---|---|---|---|---|---|
| L | 13.65 | 14.23 | 6.4 | 6.2 | 6.1 | 6 | 5.1 | 5.6 | 4.1 | 4.1 | 4.2 | 3.5 | 3.4 |
| OD | | | | | | | 1.8 | 3.2 | 2.5 | 2.8 | 3.7 | 3.6 | 4.1 |

A range of enamel coating compositions have thus been developed for use in coating a glass substrate which is subsequently press-bent and subjected to a chemical strengthening process. The enamel compositions survive the subsequent processing steps while retaining good aesthetic appearance. Furthermore, the enamel coatings retain good mechanical adhesion properties. Further still, and critical for end applications, the coated articles have high mechanical strength compared to previous enamel coated, chemically strengthened articles which were found to have a significantly decreased strength when compared to chemical strengthened glass substrates without the enamel coating. Finally, it has been shown that by tailoring the compositions it is possible to achieve a range of optical characteristics including dark coloured, high optical density coatings for obscuration applications.

While this invention has been particularly shown and described with reference to certain examples, it will be understood to those skilled in the art that various changes in form and detail may be made without departing from the scope of the invention as defined by the appended claims.

1. A paste for coating a glass substrate which, after coating, is subjected to firing and chemical strengthening by ion exchange to form an enamel coated, chemically strengthened glass product, the paste comprising:
an organic carrier fluid;
a first inorganic frit having a first softening point; and
a second inorganic frit having a second softening point,
wherein the softening point of the first inorganic frit is higher than the softening point of the second inorganic frit such that the second inorganic frit can be softened and sintered at a temperature lower than the softening point of the first inorganic frit, and
wherein the first inorganic frit comprises an exchangeable ion content which can be ion exchanged to chemically strengthen the first inorganic frit.

2. The paste according to claim 1,
wherein the first inorganic frit is a glass frit.

3. The paste according to claim 2,
wherein the first inorganic frit is an aluminosilicate glass frit, optionally comprising 50-70 wt % SiO₂ and 15-25 wt % Al₂O₃.

4. The paste according to claim 1,
wherein the first inorganic frit comprises alkali metal ions as the exchangeable ion content for chemically strengthening.

5. The paste according to claim 4,
wherein the exchangeable ion content of the first inorganic frit is a sodium ion content which is exchangeable with potassium ions when placed in a molten bath comprising potassium ions.

6. The paste according to claim 1,
wherein the first inorganic frit comprises an amount of exchangeable ions, defined by weight of the equivalent oxide, of: no more than 15 wt %, 12 wt %, 10 wt % or 9 wt %; no less than 6 wt %, 7 wt %, or 8 wt %; or within a range defined by any combination of the aforementioned upper and lower limits.

7. The paste according to claim 1,
wherein the first inorganic frit has a softening point of: no less than 500° C., 550° C., 575° C., 600° C., 650° C., 700° C., 750° C., or 800° C.; no more than 1000° C., 900° C., or 850° C.; or within a range defined by any combination of the aforementioned upper and lower limits.

8. The paste according to claim 1,
wherein the paste comprises an amount of the first inorganic frit, as a weight percentage of a solid content of the paste, of: no more than 50 wt %, 40 wt %, 30 wt %, 20 wt %, or 15 wt %; no less than 2 wt %, 5 wt %, 8 wt %, or 10 wt %; or within a range defined by any combination of the aforementioned upper and lower limits.

9. The paste according to claim 1,
wherein the second inorganic frit is a glass frit.

10. The paste according to claim 9,
wherein the second inorganic frit is a bismuth silicate glass frit or a zinc borosilicate glass frit, preferably a bismuth silicate glass frit comprising 40-70 wt % Bi₂O₃ and 10-40 wt % SiO₂.

11. The paste according to claim 1,
wherein the second inorganic frit also comprises an exchangeable ion content which can be ion exchanged to chemically strengthen the second inorganic frit.

12. The paste according to claim 11,
wherein the exchangeable ion content of the second inorganic frit is lower than the exchangeable ion content of the first inorganic frit.

13. The paste according to claim 1,
wherein the second inorganic frit comprises an amount of exchangeable ions, defined by weight of the equivalent oxide, of: no more than 6 wt %, 5 wt %, 4 wt % or 3.5 wt %; no less than 0 wt %, 1 wt %, 2 wt %, or 2.8 wt %; or within a range defined by any combination of the aforementioned upper and lower limits.

14. The paste according to claim 1,
wherein the second inorganic frit has a softening point of: no more than 650° C., 600° C., 575° C., 550° C., or 500° C.; no less than 350° C., 375° C., 400° C., 425° C., 450° C., or 475° C.; or within a range defined by any combination of the aforementioned upper and lower limits.

15. The paste according to claim 1,
wherein the second inorganic frit has a sintering temperature, within the paste composition, in a range 700° C. and 850° C.

16. The paste according to claim 1,
wherein the first inorganic frit is not sinterable at a temperature in a range 700° C. and 850° C.

17. The paste according to claim 1,
wherein the paste comprises an amount of the second inorganic frit, as a weight percentage of a solid content of the paste, of: no more than 80 wt %, 60 wt %, 50 wt %, 45 wt % or 43%; no less than 20 wt %, 30 wt % or 40 wt %; or within a range defined by any combination of the aforementioned upper and lower limits.

18. The paste according to claim 1, wherein the first inorganic frit has a coefficient of thermal expansion which is lower than a thermal expansion coefficient of the second inorganic frit.

19. The paste according to claim 1,
further comprising a pigment.

20. A method for chemically strengthening a glass substrate, comprising depositing a paste as claimed in claim 1, on a surface of the glass substrate.

21. A method of coating a glass substrate comprising:
depositing a paste according to claim 1 onto a glass substrate, the glass substrate comprising an exchangeable ion content which can be ion exchanged to chemically strengthen the glass substrate, and wherein the glass substrate has a softening point higher than the softening point of the second inorganic frit of the paste;
heating the glass substrate to sinter the second inorganic frit of the paste forming an enamel coated glass substrate; and
subjecting the enamel coated glass substrate to an ion exchange process to exchange at least a portion of the exchangeable ion content in the substrate and the first inorganic frit to chemically strengthen the enamel coated glass substrate.

22. The method according to claim 21,
wherein the glass substrate comprises the same exchangeable ions as the first inorganic frit.

23. The method according to claim 21,
wherein the glass substrate is an aluminosilicate glass.

24. The method according to claim 21,
wherein the glass substrate comprises an amount of exchangeable ions, defined by weight of the equivalent oxide, of: no more than 15 wt %, 12 wt %, 10 wt % or 9 wt %; no less than 6 wt %, 7 wt %, or 8 wt %; or within a range defined by any combination of the aforementioned upper and lower limits.

25. The method according to claim 21,
wherein the glass substrate has a softening point of: no less than 500° C., 550° C., 575° C., 600° C., 650° C., 700° C., 750° C., or 800° C.; no more than 1000° C., 900° C., or 850° C.; or within a range defined by any combination of the aforementioned upper and lower limits.

26. The method according to claim 21,
wherein the glass substrate has a thermal expansion coefficient which is more closely matched to the first inorganic frit than the second inorganic frit.

27. The method according to claim 21,
wherein the glass substrate is formed of the same material as the first inorganic frit in the paste.

28. The method according to claim 21,
wherein the heating comprises heating the glass substrate to a temperature between the softening temperatures of the first and second inorganic frits of the paste to sinter the second inorganic frit forming the enamel coated glass substrate without exceeding the softening point of the first inorganic frit or the glass substrate.

29. The method according to claim 21,
wherein the glass substrate is further subjected to press-bending to shape the glass substrate after depositing the paste on the substrate and prior to subjecting the glass substrate to the ion exchange process to chemically strengthen the glass substrate.

30. The method according to claim 29,
wherein the substrate is shaped by press-bending at the same time as the second inorganic frit is sintered to form the enamel coating on the glass substrate.

31. The method according to claim 21,
wherein the ion exchange process comprises placing the enamel coated glass substrate in a molten ion exchange bath.

32. A coated glass product manufactured by the method according to claim 21.
